(19) United States
(12) Patent Application Publication
(10) Pub. No.: US 2011/0127864 A1
(43) Pub. Date: Jun. 2, 2011

(54) FLOW PRODUCTION UNIT

(75) Inventor: Peter Jungklas NYBO, Randers SV (DK)

(73) Assignee: GRUNDFOS MANAGEMENT A/S, Bjerringbro (DK)

(21) Appl. No.: 12/958,443

(22) Filed: Dec. 2, 2010

(30) Foreign Application Priority Data
Dec. 2, 2009 (EP) 09 014 934.5-2207

(51) Int. Cl. H02K 5/132

(52) U.S. Cl. 310/87

(57) ABSTRACT

A flow production unit for submerged operation in a fluid includes an impeller and a magnet gear having an input side and an output side, each side having an arrangement of magnetic poles, wherein the arrangements of magnetic poles are coupled in movement to one another by way of magnetic fields. A transmission ratio exists between an input side and output side of the magnet gear. The output side of the magnet gear is coupled in movement to the impeller for drive thereof. The electric motor for drive of the magnet gear is coupled in movement to its input side. An encapsulation is present, which commonly encapsulates the electric motor and the arrangement of magnetic poles of the input side of the magnet gear together in a fluid-tight manner, and separates them from the output side of the magnet gear.

### BACKGROUND OF THE INVENTION

Embodiments of the invention relate to a flow production unit in the form of a recirculation pump, of a mixer or of a flow accelerator with an impeller, which is designed for submerged operation in a fluid.

With submerged operation of flow production units in fluids, such as for example with recirculation pumps in sewage treatment works, maintenance and repair costs form a large proportion of the total operating costs. It is particularly the maintenance and, as the case may be, a necessary exchange of moving parts which requires some effort and is costly with flow production units operating in a submerged manner. Disadvantageously, wear as well as deposits on or between moving parts may compromise the functional performance of flow production units and therefore demand a frequent maintenance as well as repairs. Moreover, flow production units require reliable seals, in order to prevent the access of fluid to electrical or mechanical components, as well as deposits. In particular, the dynamic seals required for this are to be exchanged at regular intervals, which additionally intensifies the maintenance expense.

### BRIEF SUMMARY OF THE INVENTION

Against this background, it is an object of the invention to provide a flow production unit in the form of a recirculation pump, a mixer or a flow accelerator, which has a significantly reduced maintenance expense.

A flow production unit according to a preferred embodiment of the invention is designed for submerged operation in a fluid, and is a recirculation pump, a mixer or a flow accelerator. The flow production unit includes an impeller as well as an electric motor and includes a magnet gear which has an input side and an output side, in each case with an arrangement of magnetic poles. The input side of the magnet gear in the context of this application thereby is to be understood as the drive side of the magnet gear. The output side in this context is to be equated with the driven side of the magnet gear.

The arrangements of magnetic poles at the input side and output side are coupled in movement to one another by way of magnet fields, wherein a transmission ratio exists between the input side and the output side of the magnet gear. The output side of the magnet gear of the flow production unit according to the invention is coupled in movement to the impeller for driving the impeller. The electric motor is coupled in movement to the input side of the magnet gear for driving of the magnet gear. The magnet gear thereby on the one hand performs a rotational speed/torque conversion, by way of which the rotational speed of the electric motor is reduced to the required rotational speed of the impeller. On the other hand, with the magnet gear of the flow production unit according to the invention, the input side and output side are coupled in movement in a magnetic and thus contactless manner. For this reason, the parts of the magnet gear, which move with respect to one another, are not subjected to any wear. Lubrication, maintenance and in particular an exchange of the magnet gear due to wear are thus advantageously done away with. The magnet gears of the flow production unit according to the invention therefore permit an operation of the flow production unit which in this respect is free of maintenance. Moreover, with magnet gear coupling in a contact-free manner, it is not necessary to seal the respective shafts in each case at the input side and output side, which regard to the penetration of water. Advantageously, the flow production unit according to the invention thus requires less or no dynamic seals.

According to a preferred embodiment of the invention, an encapsulation is provided, which commonly encapsulates the electric motor and the arrangement of magnetic poles of the input side of the magnet gear. The impeller is thereby arranged outside this encapsulation and is preferably formed in a detached manner, so that it rotates preferably in a free manner in the fluid to be delivered. It is indeed the entry of fluid with electric motors which is particularly critical for the operation of flow production units. A fluid entry into the region of the electric motor according to the invention is permanently ruled out and requires no maintenance, since one does not need to lead any shaft to the outside out of the fluid-tight encapsulation for the drive of the impeller.

The encapsulation separates the electric motor and the arrangement of magnetic poles of the input side of the magnet gear from the output side of the magnet gear. Additional dynamic seals, such as for example shaft seals on a drive shaft of the impeller or an input shaft of the gear, are not necessary according to the invention. Thus a more reliable and low-maintenance operation of the flow production unit is possible.

Preferably, with the flow production unit according to the invention, at least part of the encapsulation arranged between the arrangements of magnetic poles of the input side and the output side of the magnet gear forms a non-magnetic separating wall. The separating wall is preferably present in the form of a can. For example, the input side arrangement of magnetic poles may be peripherally surrounded by the can, wherein the magnetic poles of the outer side of the magnet gear are arranged outside the can, roughly peripherally around the can. The non-magnetic design of the separating wall which is present as the case may be, does not essentially influence the acting manner of the magnet gear, which is based on the magnetic non-positive fit.

Usefully, with the flow production unit, the transmission ratio of the magnet gear is larger than 1, i.e. the magnet gear performs a conversion of the rotational speed and of the torque with a rotational speed greater at the input side, to lower rotational speeds at the output side. Preferably, the input side of the magnet gear thereby is coupled in movement to a high-speed wheel.

Preferably, with the flow production unit according to the invention, the arrangements of magnetic poles of the input side and output side of the magnet gear are designed in each case as a magnet ring with a multi-pole magnetization. The magnet rings of the input side and output side thereby in each case have an alternating sequence of magnetic north and south poles in the peripheral direction. The magnet rings are in each case arranged in a rotatable manner and in a manner such that the magnet rings come into interaction with one another via their magnetic fields. The coupling of the magnet rings may thereby be realized essentially similarly to the coupling of gear toothed wheels. For example, the magnet rings are designed in an annulus-like manner with magnet poles distributed over the periphery at equal distances. The magnet rings thereby are rotatable arranged in a manner such that peripheral regions of both magnet rings are adequately close to one another such that in these regions, in each case one pole of the magnet ring of the input side is engaged with a magnetically non-positive fit, to the opposite pole of the magnet ring of the output side, similar to a toothing. In this manner, a rotational movement of the magnet ring of the input side is coupled in rotational movement to a rotational movement of the magnet ring of the output side.

Preferably, with the flow production unit, the magnet ring of the input side and the magnet ring of the output side of the magnet gear are rotatably arranged about rotation axes running parallel to one another. Usefully, the impeller and a drive of the flow production unit are thereby arranged on sides of the magnet gear, which are distanced to one another in the direction of the rotation axes.

In a preferred further formation of the flow production unit according to the invention, the magnet ring of the input side and the magnet ring of the output side of the magnet gear are arranged in a rotatable manner about rotation axes, which are offset to one another. Preferably, the magnet ring of the input side of the magnet gear and the magnet ring of the output side of the magnet gear are arranged in a common plane in the manner of a spur gear. For example, the rotation axes are offset to one another by at least the sum of the two outer radii of the magnet rings. Alternatively, one of the magnet rings may also be peripherally surrounded by the respective other magnet ring.

Preferably, the magnet ring of the input side of the magnet gear has a lower number of poles than the magnet ring of the output side. In this case, a transmission ratio of the magnet gear being larger than 1 is ensured, as long as the magnetic poles of the input side and the magnetic poles of the output side always couple with one another with a non-positive in pairs along peripheral regions of the magnetic rings, said regions being close to one another. In this case, the transmission ratio is determined as a ratio of the number of poles of the output side and the number of poles of the input side of the magnet gear, analogous to a gear mechanism.

Preferably, with regard to the flow production unit according to the invention, the magnet ring of the input side of the magnet gear has a smaller radius than the magnet ring of the output side. For example, the magnet rings of the input side and of the output side have the same peripheral extensions of the poles and—similar to gearwheels—are coupled in a rotational movement with identical circular speeds and thereby form a transmission ratio of greater than one. In this case, the magnet ring of the input side at the same time has a lower number of magnetic poles.

Particularly preferably, the magnet ring of the input side of the magnet gear is peripherally surrounded by the magnet ring of the output side. For example, the magnet ring of the input side and the magnet ring of the output side are arranged in a common plane. In this manner, the magnet gear and thus also the flow production unit may be realized in a space saving manner.

Further preferably, the arrangements of magnetic poles of the input side and the output side of the magnet gear may also be coupled in movement to one another by way of magnetic fields via additional intermediate stages of the magnet gear, for example via rotatable magnet rings lying intermediately between the input side and the output side.

In a preferred further formation of the flow production unit according to the invention, the magnet gear comprises an arrangement of stationary yokes between the arrangements of magnetic poles of the input side and the output side of the magnet gear, said arrangement of yokes being designed for forming the transmission ratio.

For example, thereby the arrangements of magnetic poles of the input side and output side of the magnet gear are in each case designed as a magnet ring with a multi-pole magnetization in the peripheral direction. Preferably, the magnet rings of the input side and output side of the magnet gear are arranged concentrically to one another as circular rings. Particularly preferably, the yokes are likewise arranged along a concentric circle between the input side and output side of the magnet gear and are arranged distributed over the periphery at equal distances. Usefully, the number of yokes differs from the number of north poles of the input side or output side of the magnet gear, in particular in a slight manner. The deviation of the yoke number from the number of north poles of the input side or output side of the magnet gear then results in a transmission ratio which differs from 1.

This is explained hereinafter by way of an example of an arrangement with which the number of yokes differs slightly from the number of north poles of an outer magnet ring belonging to the output side of the magnet gear. For this, firstly only the output side magnet ring with the inner-lying annulus-shaped arrangement of the yokes is considered. If the number of the yokes were to correspond to the number of north poles, then an equal type of arrangement of magnetic poles would be present on each yoke with respect to the outer magnet ring alone. If however the number of yokes is, for example, reduced by 1 with respect to the number of north poles of the outer, output side magnet ring, then the arrangement of magnetic poles relative to the yoke is no longer the same with all yokes, but differs slightly from yoke to yoke. This necessitates a resulting, effective magnetic field within the circular ring on which the yokes are arranged, said field being modulated in the peripheral direction in a manner such that it has a north pole and south pole. Then an effective modulating field similar to the field of a two-pole magnetic ring is present.

If the number of yokes differs from the number of north poles of the output side magnet ring generally by the number n, then an effective magnetic field results within the arrangement of stationary yokes and this field is modulated n-times in the peripheral direction, thus has n north poles. A rotation of this effective magnetic field by 360°/n about the rotation axis of the output side magnet ring corresponds to a rotation of the outer magnet ring relative to a stationary yoke by the peripheral extension of one of its pole pairs. Accordingly, a transmission ratio with respect to the rotational speed exists between the inner effective field and the orientation of the outer magnet ring.

This effective magnetic field formed within the arrangement of stationary yokes is now coupled to an inner, input side magnet ring of the magnet gear. The inner magnet ring may now couple in rotational movement to the effective magnetic field of the outer magnet ring, said field being located within the arrangement of the yokes, and thus this inner magnet ring may set the outer output side magnet ring into rotation. Usefully, for this, the input side magnet ring has the same number of north poles n as the effective magnetic field within the yokes. Advantageously then, the input side magnet ring is coupled in movement with a magnetic non-positive fit to the output side magnet ring over the whole periphery of the magnet rings, so that an efficient rotational movement may be effected.

It is to be understood that with the previously described further formation of the invention, the number of yokes may also differ upwards from the number of north poles of the output side. Moreover, the number of yokes may also differ, in particular slightly, from the number of north poles of the input side. Particularly preferably, with the flow production unit according to the invention, such as described in the previous example, the number of yokes differs from the number of north poles of the output side at least by the number of the north poles of the input side.

Further preferably, the input side and/or inner magnet ring may also be arranged eccentrically to the outer magnet ring and couple with the effective magnetic field within the arrangement of stationary yokes, in the form of a gearwheel mechanism. Thereby, it is sufficient if yokes are provided only in those peripheral regions, in which a strong magnetically non-positive fit movement coupling of the input side and output side magnet ring is effected. It is to be understood that more than two rotatable magnet rings may be provided concentrically to one another with intermediately lying arrangements of stationary yokes, which form stages of a multistage magnet gear.

Usefully, the yokes as the case may be are arranged on/in a separating wall separating the input side and the output side of the magnet gear.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow production unit according to the invention, in a schematic representation,

FIG. 2 the electric motor and the magnet gear of the flow production unit according to FIG. 1, schematically in a longitudinal section,

FIG. 3 the arrangement of the magnet rings of the input side and the output side of the magnet gear according to FIGS. 1 and 2, schematically in cross section,

FIG. 4 the electric motor and an alternatively designed magnet gear of a flow production unit according to the invention, schematically in a longitudinal section, and

FIG. 5 the arrangement of the magnet rings of the input side and the output side of the magnet gear according to FIG. 4, schematically in cross section.

### DETAILED DESCRIPTION OF THE INVENTION

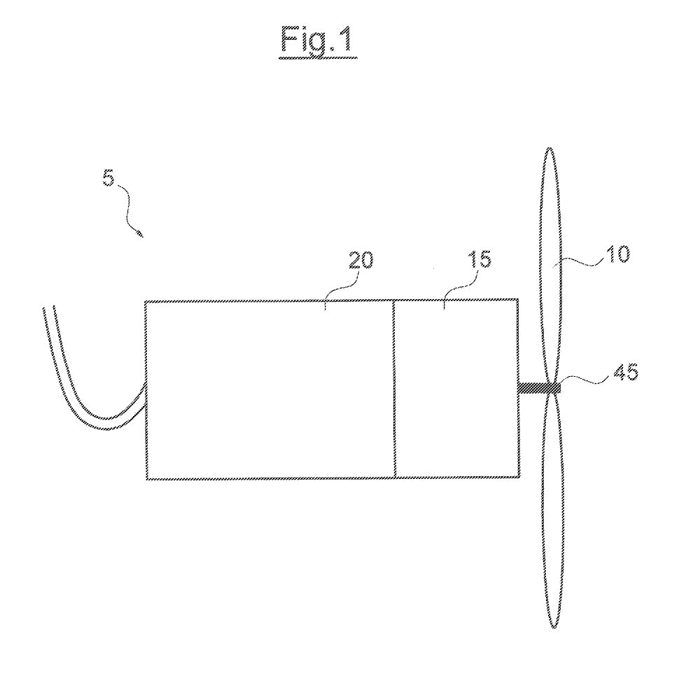

The flow production unit shown in FIG. 1 is a flow accelerator 5 designed for submerged operation (the manner of functioning described hereinafter may be applied without further ado to recirculation pumps or mixers). The flow accelerator 5 for flow acceleration includes a detached impeller 10. For the drive, the impeller 10 is coupled in movement to the output side of a magnet gear 15 of the flow accelerator 5. An electric motor 20 of the flow accelerator 5 is arranged on the side of the magnet gear 15, which is distant to the impeller 10, and is coupled in movement to the input side of the magnet gear 15.

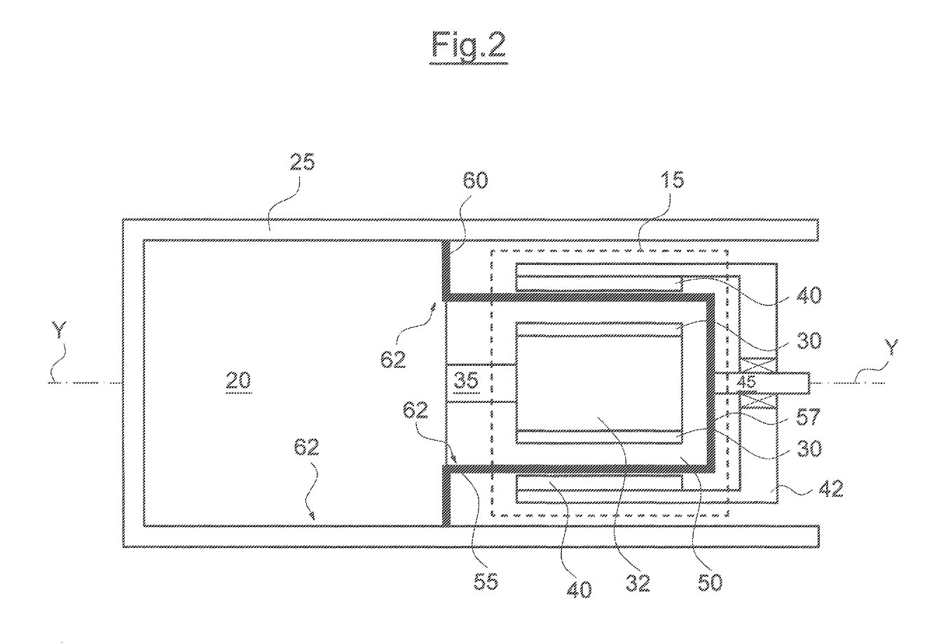

The magnet gear 15 and the electric motor 20 have a common, essentially cylindrical housing 25 (FIG. 2). The magnet gear 15 of the flow accelerator 5 has an input side magnet ring 30 which, via a shaft 35 (connected by way of a hub 32), is coupled in movement in a rotational fixed manner to the electric motor 20. The magnet gear 15 further includes an output side magnet ring 40, which, via a drive shaft 45 (connected by way of a frame 42) which extends parallel to the shaft 35, is coupled in movement in a rotationally fixed manner to the impeller 10. The input side 30 and output side magnet ring 40 thereby form cylinder-surface-shaped rings 30, 40 whose cylinder axes extend axially, i.e., parallel, to the longitudinal axis of the shaft 45, to which the impeller 10 is connected.

Thereby, an annulus-shaped air gap 50 is formed between the input side magnet ring 30 and the output side magnet ring 40. In the region of this air gap 50, the input side magnet ring 30 is encased in a fluid-tight manner by a pot-like, essentially axially extending separating wall 55, which at the axial end of the magnet ring 30, which is close to the impeller 10, terminates with a radially extending base 57. The separating wall 55 and the base 57 include a non-magnetic, electrically insulating material, here plastic. The separating wall 55 with a collar 60 projects radially at the electromotor-side end of the shaft 35 connected to the electric motor 20. The collar 60 is connected to the housing 25 in a tight manner. The separating wall 55, base 57, collar 60 and housing 25 together form an encapsulation 62 which encloses the electric motor 20 together with the input side magnet ring 30 of the magnet gear, in a fluid-tight manner. The encapsulation 62 separates the electric motor 20 and the input side magnet ring 30 from the output side magnet ring 40 and the impeller 10 arranged outside the encapsulation 62.

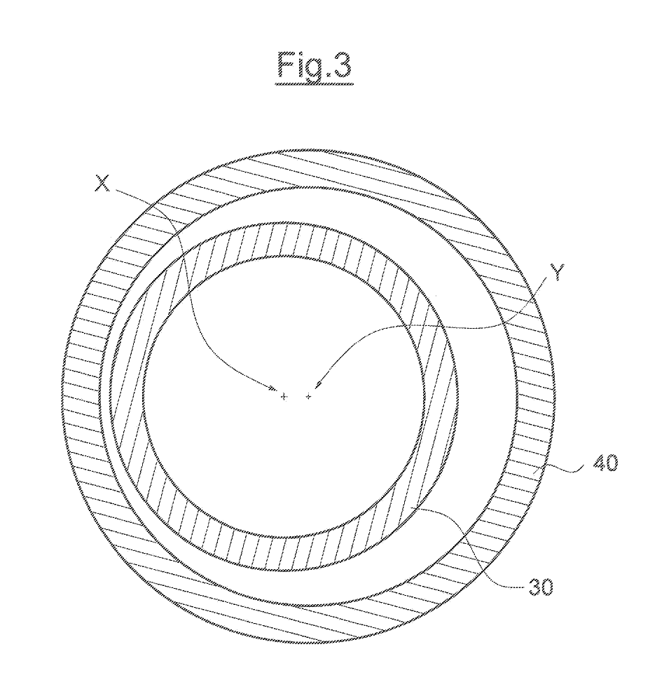

The input side magnet ring 30 and the output side magnet ring 40 are arranged eccentrically to one another about rotation axes X (magnet ring 30) (see FIG. 3) and Y (magnet ring 40), which are parallel to one another. The rotation axes thereby are offset to one another in a plane, so that in FIG. 2 therefore only one rotation axis Y is to be recognized. The input side magnet ring 30, as well as the output side magnet ring 40, thereby have a succession of magnetic north and south poles in the peripheral direction (not shown in detail in the drawings). The magnetic poles or pole pairs of the input side magnet ring 30 thereby in each case assume equally long peripheral sections as the poles or pole pairs of the output side magnet ring 40. The input side magnet ring 30 is therefore coupled in movement to the output side magnet ring 40 similarly to gearwheels, here in the manner of an outer-toothed input side with an inner-toothed output side of the toothed gear mechanism. The magnet gear 15 has a transmission ratio of greater than 1 as a result of the smaller diameter of the input side magnet ring 30 and the pole number which is lower compared to the output side magnet ring 40.

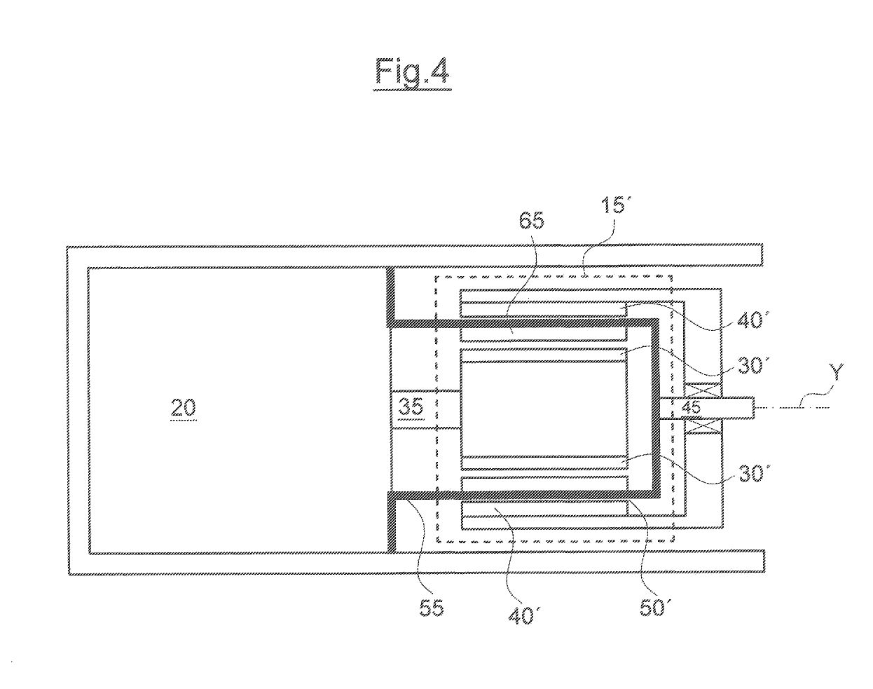

A further embodiment example of a flow accelerator according to the invention is shown in FIG. 4. The flow accelerator is constructed in essentially the same manner as the flow accelerator 5 in FIG. 1, so that FIG. 1 is referred to with regard to this embodiment example. The inner construction too also corresponds largely to the inner construction of the flow accelerator 5 represented in FIG. 2. What differs however with the magnet gear 15′ is that the input side magnet ring 30′ and the output side magnet ring 40′ are arranged concentrically to one another.

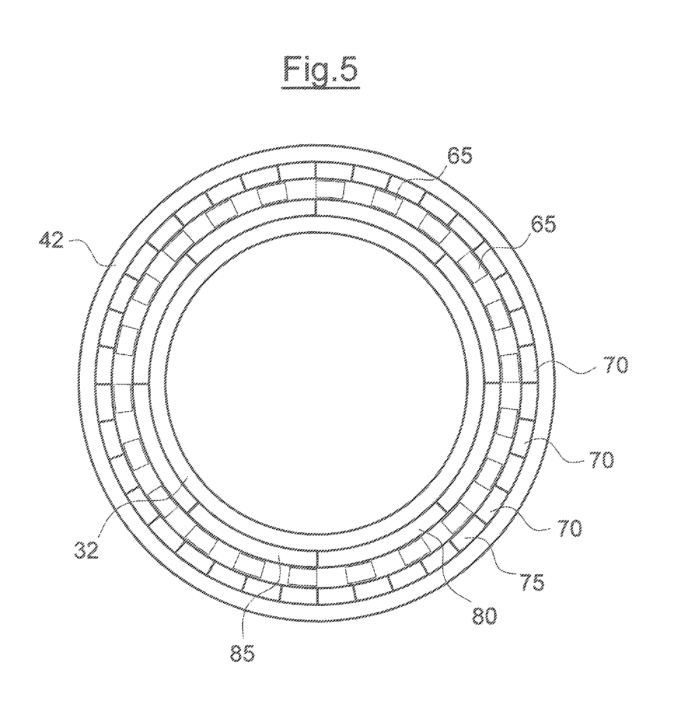

Equidistant yokes 65 are distributed inner peripherally of the separating wall 55, for ensuring a transmission ratio. The yokes 65 are arranged between the input side magnet ring 30′ and the output side magnet ring 40′ on a concentric circular ring. The number of yokes 65 thereby differs from the number of north poles of the output side magnet ring 40′. In the represented embodiment example, the output side magnet ring 40′ comprises 18 north poles 70 (or 18 south poles 75), as represented in FIG. 5. The number of yokes 65 in this embodiment example is 22. In this manner, the output side magnet ring 40′ and the yokes 65 cooperate for producing an inner-lying effective magnetic field, which comprises four modulation periods, i.e. four north poles and four south poles.

The input side magnet ring 30′ along the peripheral direction includes four north poles 80 and four south poles 85, adapted to this inner magnetic, effective field. The sum of the number of north poles 80 of the input side magnet ring 30′ and the north poles 70 of the output side magnet ring 40′ corresponds exactly to the number 22 of the intermediately lying yokes 65. The transmission ratio of the magnet gear 15′ in this case results as the ratio of the numbers of north poles 70 of the output side magnet ring 40′ and the number of north poles 80 of the input side magnet ring 30′ at 4.5.

In a further embodiment example (not represented in the drawing), the above-discussed different designs of a magnet gear 15, 15′ may be combined with one another. For example, differing from the last-described embodiment example, the input side magnet ring 30′ may be rotatable eccentrically about an offset rotation axis running parallel to the rotation axis of the output side magnet ring 40′. In this case, the input side magnet ring 30′ in the manner of a toothed gearing, couples to the effective magnetic field produced by the output side magnet ring 40′ and the yokes 65. Schematically, the relative arrangement of the input side magnet ring 30′ and of the output side magnet ring 40′ may correspond to the arrangement of the input side magnet ring 30 and of the output side magnet ring 40 which is represented in FIG. 3.

In a further, not separately represented embodiment example, the magnet gear 15 is constructed in a multi-stage manner and comprises more than two magnet ring pairs which are arranged next to one another or around one another. In a further embodiment example, the magnet gear 15′ is constructed in a multi-stage manner and comprises more than two magnet rings which are arranged concentrically to one another and which in each case are separated from one another via concentric arrangements of stationary yokes. The above described designs 15, 15′ of the magnet gear may be freely combined with one another, inasmuch as this makes sense.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A flow production unit for submerged operation in a fluid and which is a recirculation pump, a mixer or a flow accelerator (5, 5′), with an impeller (10) and an electric motor (20), the flow production unit comprising:
a magnet gear (15, 15′) which comprises an input side and an output side, in each case with an arrangement (30, 30′, 40, 40′) of magnetic poles (70, 75, 80, 85), the arrangements (30, 30′, 40, 40′) of magnetic poles (70, 75, 80, 85) being coupled in movement to one another by way of magnetic fields, a transmission ratio existing between an input side and output side of the magnet gear (15, 15′), the output side of the magnet gear (15, 15′) being coupled in movement to the impeller (10) for driving the impeller, the electric motor (20) for the drive of the magnet gear (15, 15′) is coupled in movement to the input side of the magnet gear, and
an encapsulation (62) which commonly encapsulates the electric motor (20) and the arrangement (30, 30′) of magnetic poles (80, 85) of the input side of the magnet gear (15, 15′) in a fluid-tight manner, and separates the arrangement of magnetic poles of the input side of the magnet gear from the output side of the magnet gear (15, 15′).

2. The flow production unit according to claim 1, wherein at least one part of the encapsulation (62) forms a non-magnetic separating wall (55), the at least one part being arranged between the arrangements (30, 30′, 40, 40′) of magnetic poles (70, 75, 80, 85) of the input side and the output side of the magnet gear (15, 15′).

3. The flow production unit according to claim 1, wherein at least one part of the encapsulation (62) forms an electrical insulator, the at least one part being arranged between the arrangements (30, 30′, 40, 40′) of magnetic poles (70, 75, 80, 85) of the input side and output side of the magnet gear (15, 15′).

4. The flow production unit according to claim 1, wherein the transmission ratio of the magnet gear (15, 15′) is larger than one.

5. The flow production unit according to claim 1, wherein the arrangements (30, 30′, 40, 40′) of magnetic poles (70, 75, 80, 85) of the input side and output side of the magnet gear (15, 15′) are in each case designed as a magnet ring (30, 30′, 40, 40′) with a multi-pole magnetization.

6. The flow production unit according to claim 5, wherein the magnet ring (30, 30′) of the input side and the magnet ring (40, 40′) of the output side of the magnet gear (15, 15′) are rotatably arranged about rotation axes (X, Y) running parallel to one another.

7. The flow production unit according to claim 5, wherein the magnet ring (30, 30′) of the input side and the magnet ring (40, 40′) of the output side of the magnet gear are rotatably arranged about rotation axes (X, Y) which are offset from one another.

8. The flow production unit according to claim 5, wherein the magnet ring of the input side of the magnet gear has a lower number of poles (80, 85) than the magnet ring of the output side of the magnet gear.

9. The flow production unit according to claim 5, wherein the magnet ring (30, 30′) of the input side of the magnet gear (15, 15′) has a smaller radius than the magnet ring (40, 40′) of the output side of the magnet gear.

10. The flow production unit according to claim 9, wherein the magnet ring of the input side of the magnet gear is peripherally surrounded by the magnet ring of the output side (40, 40′) of the magnet gear.

11. The flow production unit according to claim 1, wherein the magnet gear (15′) between the arrangements (30′, 40′) of magnetic poles (70, 75, 80, 85) of the input side and output side of the magnet gear (15′) has an arrangement of stationary yokes (65), which defines the transmission ratio.

12. The flow production unit according to claim 5, wherein the magnet rings (30′, 40′) of the input side and output side are arranged concentrically with respect to one another.

13. The flow production unit according to claim 11, wherein the number of yokes (65) differs from the number of north poles (70) of the magnet ring of the output side of the magnet gear by at least the number of the north poles (80) of the magnet ring (30, 30′) of the input side of the magnet gear.
